(19) United States
(12) Patent Application Publication
(10) Pub. No.: US 2008/0240826 A1
(43) Pub. Date: Oct. 2, 2008

(54) Systems and methods for extending printer availability

(75) Inventor: Zhongming Shen, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 11/731,451

(22) Filed: Mar. 29, 2007

(51) Int. Cl. B41J 5/02

(52) U.S. Cl. 400/62

(57) ABSTRACT

Embodiments of systems and methods for extending printing device availability detect a level of printing consumable, compare the detected level of printing consumable to a threshold level, provide a selection of printing modes if the detected level of printing consumable is less than the threshold level, and control the printing device to print in the selected printing mode. Printing device availability-extending modes include printing in a lower resolution, simulating black with a composite of colors, and/or printing in a substitute color when the level of one or more colors is low. The methods disclosed are applicable to a variety of printing devices including laser printers, ink-jet printers, LED printers, plotters, facsimile machines, digital copiers and multi-function printing devices.

### BACKGROUND

1. Field of the Invention

The present invention relates to the field of printing, and in particular, to systems and methods for extending printer availability.

2. Description of Related Art

Users may adjust the output of a printer by selecting one of a number of available printing modes. For example, a “photo” mode permits printing in an ink-rich or toner-rich condition for high-quality photos. On the other hand, a “draft” mode permits printing in a low-ink or low-toner mode for lower quality printing. Printing systems may also provide users with warnings when the level of a particular printer consumable is too low for printing. A user may be warned if a print job has been interrupted due to depletion of paper and may be advised to refill the appropriate printer tray in order to resume the interrupted print job.

Unfortunately, with such conventional printing systems and methods, the depletion of one or more printer consumables may result in the frustrating interruption of a print job, which may require a user to cease all printing until the depleted consumable has been replenished. Printer systems and methods often do not provide users with sufficient notice of consumable deficiencies prior to their total depletion. Even if sufficient notice of a deficiency is given, the user is not provided with options to extend printer availability. In a home environment, printer non-availability may be inconvenient because residential users typically do not maintain a sufficient inventory of replacement printer consumables. Printer interruptions may be even more onerous in the commercial workplace, where down-time is extremely costly and potentially devastating to business functions. In some cases, printer consumables may need to be ordered for delivery by mail, in which case a user may be without printing capabilities for an extended period of time. Accordingly, there is a need for systems and methods for extending printer availability.

### SUMMARY

In some embodiments, systems and methods for extending the availability of a printing device comprise comparing the detected level of at least one print consumable used by the printing device to a threshold level; selecting at least one of several printing modes if the detected level of the at least one print consumable is less than the threshold level; and controlling the printing device to print in the selected printing mode. In one embodiment, the threshold level may be predetermined. In other embodiments, the threshold level may determined based on image and size characteristics of a current print job; or determined based on a trend of consumption of the print consumable.

The selection of printing modes may be performed automatically or by a user. The selectable printing modes may include decreasing output resolution of the printed image; simulating black with a composite of colors, if the detected level of black is less than the threshold level for black; and/or rendering an image in a different color, if the detected level of at least one specified color is less than the threshold level for that color.

The methods disclosed are applicable to a variety of printing devices including laser printers, ink-jet printers, LED printers, plotters, facsimile machines, digital copiers and multi-function printing devices. Further, print consumables may comprise one or more of ink, toner, paper, space available in a waste container, transfer belts, ink cartridges, and toner cartridges.

These and other embodiments are further explained below with respect to the following figures.

### BRIEF DESCRIPTION OF THE DRAWINGS

FIGS. 1A and 1B illustrate various document production systems.

FIG. 2 is a block diagram showing components of a system to extend print availability.

FIG. 3 is a flowchart for an exemplary algorithm for extending print availability.

### DETAILED DESCRIPTION

In some embodiments, systems and methods for extending printer availability provide users with one or more operation-extending printing modes.

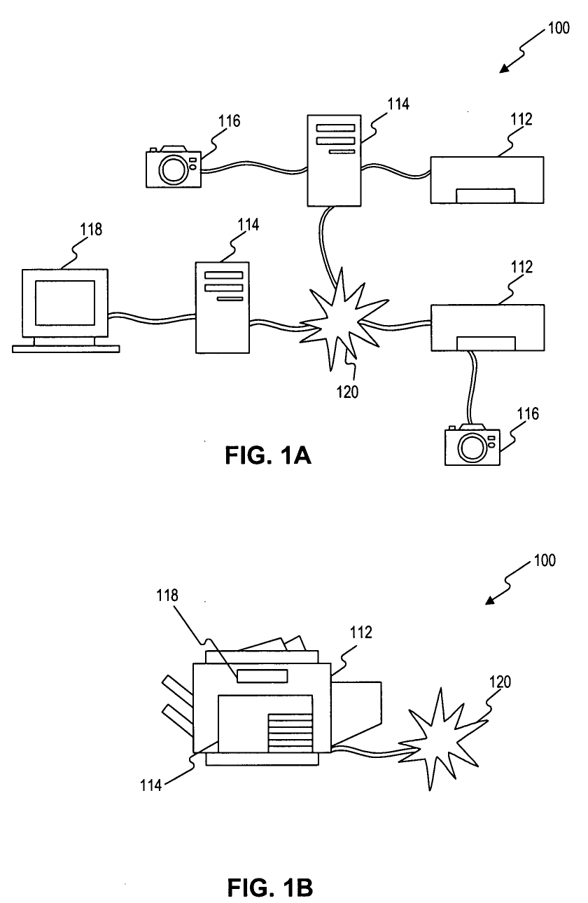

FIG. 1 illustrates exemplary embodiments of a document production system. As shown in FIG. 1A, an exemplary document production system 100 may include one or more printing devices 112 that communicate with one or more computing devices 114.

Exemplary computing device 114 may be a computer workstation, desktop computer, laptop computer, or any other computing device capable of communicating with printing device 112. Computing device 114 may include a central processing unit (CPU) and a display monitor 118, such as a CRT or LCD monitor. Computing device 114 may also contain a removable media drive, such as, for example, a 3.5 inch floppy drive, CD-ROM drive, DVD-ROM drive, CD±RW or DVD±RW drive, USB flash drive, and/or any other removable media drive. In some embodiments, portions of a software application or printable matter may reside on memory or removable media and be read and executed by computing device 114. In general, one or more computer software applications may be deployed on any of the exemplary devices, as shown in FIG. 1.

Exemplary printing device 112 may be a device that produces physical documents from electronic data including, but not limited to, laser printers, ink-jet printers, LED printers, plotters, facsimile machines, digital copiers, and multi-function devices. In general, printing device 112 may be any device that produces physical images or physical documents from electronic data. Printing device 112 may be a monochrome or a color device.

In some embodiments, printing device 112 may include firmware, memory, input-output ports, and a print engine. For example, printing device 112 may include any type of Dynamic Random Access Memory (“DRAM”) such as but not limited to SDRAM or RDRAM. Printing device 112 may also contain Application Specific Integrated Circuits (ASICs), and/or Field Programmable Gate Arrays (FPGAs) that are capable of executing portions of an application to print documents according to some embodiments of the present invention. Printing device 112 may also be capable of executing software including a printer operating system and other appropriate application software. In some embodiments, printing device 112 may allow paper sizes, output trays, color selections, and print resolution, among other options, to be user-configurable. Printing device 112 may incorporate the use of one or more detectors or sensors for consumables. Consumables may include paper, ink, toner, ink cartridges, toner cartridges, transfer belts, space available in any waste tanks and/or other parts or components of printing device 112 that may need to be replaced, renewed, refilled, and/or emptied periodically.

Document production system 100 may also include other devices, such as memory devices, digital cameras 116, scanners, and/or other peripherals. As illustrated in FIG. 1A, exemplary digital camera 116 may communicate with computing device 114 and/or printing device 112. Accordingly, digital camera 116 may provide printable data to printing device 112 either directly, or via computing device 114 or network 120. In some embodiments, printing device 112 may be capable of retrieving data from a memory device for printing using information provided by a user through a console or other user-interface coupled to printing device 112. For example, memory devices such as USB drives, flash drives, portable drives, or memory sticks may be coupled to printing device 112.

Exemplary computing device 114 may communicate with printing device 112 using a wired or wireless connection using conventional communication protocols and/or data port interfaces. In one embodiment, for example, the devices may be provided with conventional data ports, such as parallel ports, serial ports, Ethernet, USB, SCSI, FIREWIRE, and/or coaxial cable ports for transmission of data through the appropriate connection. The communication links could be wireless links or wired links or any combination consistent with embodiments of the present invention that allows communication between the various devices. As illustrated in FIG. 1A, computing device 114 may communicate with printing device 112 directly, or over exemplary network 120. Network 120 may include a Local Area Network (LAN), a Wide Area Network (WAN), or the Internet.

Accordingly, a user may control exemplary printing device 112 directly, and/or from menus displayed by any device coupled to printing device 112. For example, printing device 112 may be provided with an onboard display, and/or coupled to a console, and/or coupled to a computing device 114. Exemplary printing device 112 may also be capable of displaying menus and other messages on any device coupled to computing device 114 such as on a display monitor 118, or on camera 116 using appropriate protocols such as PictBridge. In some embodiments, a user may configure printing device 112 through the use of user interface software, which may allow user-interaction with printing device 112. User interface software may run on computing device 114, printing device 112, or a print server or controller (not shown) coupled to printing device 112. In some embodiments, portions of the software may be distributed among the various devices.

In general, documents created by printing device 112 may contain one or more of text, graphics, and/or images. Print processing of documents may be performed by computing device 114, printing device 112, and/or by devices at remote locations. In one embodiment, computing device 114 and/or printing device 112 may perform portions of document print processing such as half-toning, color matching, and/or other manipulation processes before a document is physically printed by printing device 112. In another embodiment, printing device 112 may be capable of processing and directly printing documents received from devices. In some embodiments, documents for printing may be received over network 120.

As illustrated in FIG. 1B, exemplary printing device 112 may include a computing device 114 and a display monitor 118. Display monitor 118 may be a touch screen, by which a user may manipulate and control one or more functions of printing device 112. For example, display monitor 118 may provide a user with information about the status of printing device 112, and/or one or more of its components, and with the ability to select one or more printing modes of printing device 112. Printing device 112 may further communicate with exemplary network 120 for the transmission of data for printing and/or for the control of one or more functions of printing device 112. Printing device 112 may also be a user-manipulated workstation, such as a ticket machine, an automated teller machine (ATM), a point-of-sale (POS) terminal, or any other system providing print capability.

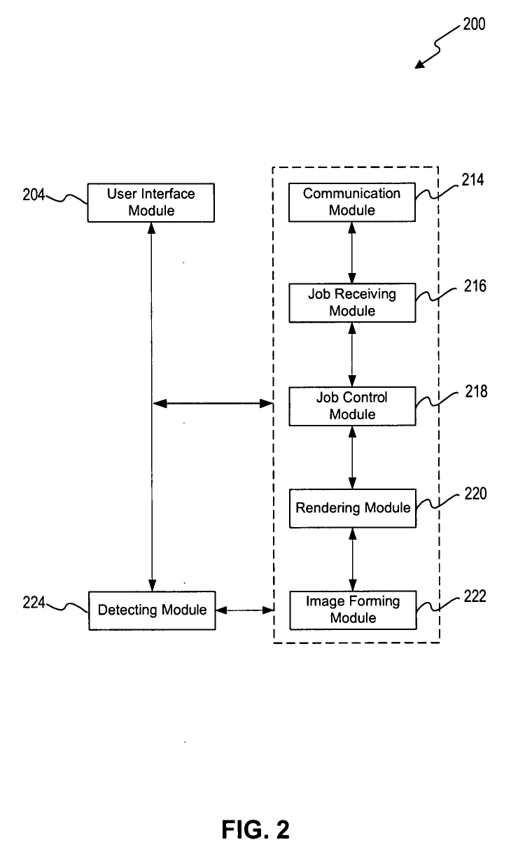

FIG. 2 shows a block diagram illustrating exemplary process flow 200 for document production system 100. As illustrated in FIG. 2, exemplary process flow 200 may include a user interface module 204 that communicates with one or more of communication module 214, job receiving module 216, job control module 218, rendering module 220, image forming module 222, and detecting module 224.

Exemplary user interface module 204 may be implemented using software and may allow users to interact with or configure any of the modules shown in FIG. 2. For example, user interface module 204 may include an application configured to control and communicate with job control module 218. Users may query or relay commands to job control module 218 or detecting module 224 through user interface module 204. Users may also receive status updates from job control module 218 and/or detecting module 224. Accordingly, users may manipulate the sequencing of, and/or settings relating to, a plurality of print jobs in job control module 218 by using user interface module 204. User interface module 204 may also facilitate user communication with one or more of any of the other modules shown in FIG. 2. In some embodiments, user interface module may be used to pre-configure settings in the various other modules. The pre-configured settings may be used automatically by the individual modules and may be used to limit or eliminate additional user input.

In general, functionality present in the various modules shown in FIG. 2 may be modified, redistributed, or combined based on system design considerations and parameters. The modules shown in FIG. 2 are illustrative only and various other configurations are possible depending on design parameters and the nature of devices used in exemplary system 200. For example, the functionality of communication module 214 may be combined with the functionality of job receiving module 216. The modules may be implemented in hardware, software, and/or firmware or by some combination of hardware, software, and/or firmware. Furthermore, the various components may all communicate with each other, using a bus, network 120, and/or via shared memory.

Communication module 214 may facilitate interaction with applications or devices that users may utilize to create print jobs. In one embodiment, exemplary communication module 214 may interact with user print applications, such as word processors, spreadsheets, databases, web browsers, entertainment software, or any other executable software program that is capable of generating printable output. In another embodiment, communication module 214 may facilitate interaction with computing device 114 on which user print applications may be running, a print controller, device drivers running on exemplary computing device 114, and/or with applications or other functional modules running on printing device 112. Exemplary communication module 214 may receive data over a conventional data port, such as a parallel port, serial port, Ethernet, USB, SCSI, FIREWIRE, and/or a coaxial cable port over network 120. In other embodiments, exemplary communication module 214 may also facilitate communications with internal printing device modules and/or components or components using internal communication paths, protocols, or shared memory. In some embodiments, communication module 214 may process the received jobs to place them in a format acceptable to job receiving module 216. In general, communication module 214 may convey print data and job information to exemplary job receiving module 216.

Job receiving module 216 may obtain print data from communication module 214 and convey print data to job control module 218. In some embodiments, exemplary job receiving module 216 may place job related information and other print data in memory shared with job control module 218. Accordingly, job receiving module 216 may provide received and stored print data to job control module 218 for further processing and manipulation by job control module 218.

Job control module 218 may receive print data from job receiving module 216 and commands from user interface module 204. Exemplary job control module 218 may be pre-configured, and/or receive automated, or user input, such as the selection of an alternate printing mode through user interface module 204. In response, job control module 218 may perform one or more processing steps on print data received from job receiving module 216. For example, job control module 218 may process print jobs including control information and instructions. For example, instructions in printer description languages (PDLs) such as postscript or PCL may be processed by job control module 218. Job control module 218 may include a memory for storing, prioritizing, handling, and transmitting print jobs. In some embodiments, job control module 218 may include a general-purpose processor, a special purpose processor, or an embedded processor. In some embodiments, the functions of job control module 218 may be performed entirely by software or by a combination of hardware and software. As illustrated in FIG. 2, job control module 218 may also communicate with, and convey print data to, rendering module 220.

Rendering module 220 may allow for rendering of a print job based on input received from job control module 218 and/or user interface module 204. In general, exemplary rendering module 220 may convert print data into a rasterized bitmap suitable for printing. In some embodiments, rendering module 220 may also act on commands received from user interface module 204. For example, rendering module 220 may configure document data in response to commands generated by the selection of a printer availability-extending mode. In some embodiments, rendering module 220 may include firmware configured to prepare document data for printing. Specifically, routines in the firmware may include code to translate print job data received from job control module 218. In some embodiments, the firmware may include rasterization routines to convert rendering commands in PDL, into a rasterized bitmap image. The firmware may also include compression routines and memory management routines. In some embodiments, data and instructions in the firmware may be upgradeable.

In other embodiments, rendering module 208 may be further configured to perform document print pre-processing functions including one or more of translation and compression algorithms. For example, rendering module 220 may perform half-toning, color matching, and/or other manipulation. At rasterization time, images may be decompressed by various decoding algorithms prior to printing. In some embodiments, rendering module 220 may be further configured to convey rendered print data to exemplary image forming module 222.

Image forming module 222 may process rasterized data in a frame buffer, and form a printable image on a print medium, such as a printed piece of paper. In some embodiments, exemplary image forming module 222 may include a print engine for forming a printable image. For example, when embodied in a laser printing device, image forming module 222 may include a toner cartridge, photoreceptor drum, transfer belt, laser unit, and fuser. When embodied in an ink-jet printing device, image forming module 222 may include one or more ink cartridges suitable for forming rasterized data on a piece of paper. Image forming module 222 may also communicate with exemplary detecting module 224.

Detecting module 224 may communicate with both image forming module 222 and user interface module 204, as illustrated in FIG. 2. Exemplary detecting module 224 may be configured to detect a level or amount of a printer consumable in image forming module 222. Detecting module 224 may also convey data regarding one or more printer consumable levels to user interface module 204. Because detecting module 224 may communicate with both user interface module 204 and image forming module 222, a user may configure detecting module 224, via user interface 204, to receive information from image forming module 222 and/or its components, as desired. For example, detecting module 224 may be controlled to collect consumable data from image forming module 222, or other components of a printing device, either continuously or intermittently. Detecting module 224 may then, either continuously or periodically, convey the collected data to user interface module 204.

In one embodiment, detecting module 224 may be configured to detect a level or amount of ink in at least one ink cartridge. In another embodiment, detecting module 224 may be configured to detect a level or amount of toner in a toner cartridge. For example, detecting module 224 may be any suitable type of sensor such as a pressure, temperature, tactile, chemical, time, or other sensor. In another embodiment, detecting module 224 may detect a volumetric dispensing of one or more ink cartridges. When associated with a toner cartridge, detecting module 224 may utilize information obtained from a sensor chip integrated into the toner cartridge. In some embodiments, detecting module 224 may be configured to detect an amount of remaining space or volume available for calculating a depletion of consumable, such as the volume remaining in a container for holding waste products that may be generated by printing device 112. In one embodiment, detecting module 224 may be a counter, such as a page counter for use in calculating a depletion of ink, toner, or paper.

In some embodiments, exemplary detecting module 224 may be configured to detect depletion of paper, in which case a paper saving mode may be selected. For example, such an embodiment of detecting module 224 may be configured to provide early warning of paper depletion. A user may be warned to refill the paper prior to starting an important print job. Users may also be prompted to select alternative printing modes, such as shrinking of document images, printing multiple document pages on a single physical page, using paper in other available paper trays, and/or double-sided printing, in order to conserve paper.

In still further embodiments, exemplary detecting module 224 may be configured to detect a near-filled condition of a waste toner container. For instance, detecting module 224 may monitor the level of waste in a waste container to determine when the level of waste is approaching a level that would necessitate emptying the waste container. Upon a determination that waste toner is above a threshold level, alternate printing modes may be implemented, such as shrinking of document images, printing of multiple document pages on a single physical page, and reducing print resolution in order to reduce the quantity of waste toner generated. Such an embodiment may prevent a user from having to interrupt a print job to empty waste. In some embodiments, detection of a near-filled condition may require comparison of a toner level to a maximum threshold, as opposed to a minimum threshold. Accordingly, detecting module 224 may be configured to generate a signal when a detected level of waste is above a predetermined threshold. In other embodiments, the space available for additional waste may be monitored and the output of detecting module 224 modified accordingly.

The various functions of modules illustrated in FIG. 2 may be moved, combined, and/or redistributed within printing device 112, and/or across one or more of the devices shown in FIG. 1. For example, user interface module 204 may be implemented in a display of printing device 112, or in menus displayed by a coupled device. Likewise, various other steps may be performed either by exemplary printing device 112 and/or a locally coupled, or a networked computing device 114, and communicated to other modules for further processing. User interface module 204 may be used to determine which consumables to monitor, to set threshold levels for various consumables, and to select or pre-set one or more print availability-extending modes.

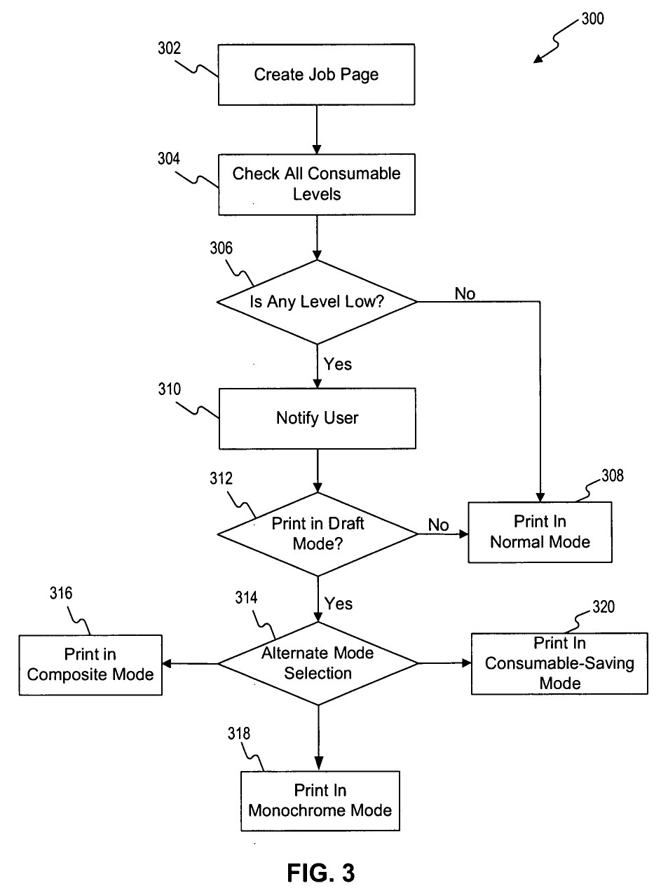

FIG. 3 shows an exemplary flowchart illustrating an algorithm 300 for extending printer availability. In step 302, a job page may be created. For example, in one embodiment, a job page may be created by a user print application. Next, in step 304, the levels of one or more of the monitored consumables may be detected. For example, in one embodiment, exemplary detecting module 224 may receive input regarding the level of various consumables from one or more sensors. Exemplary detecting module 224 may then generate output indicating the level of the consumables.

In step 306, the detected levels of one or more consumables may be compared to a predetermined threshold. For example, a predetermined threshold, such as a volume of ink, may be preset by a user, or stored within firmware or a memory device of the system. Alternatively, the detected levels of consumables may be compared to a calculated threshold. In one embodiment, the calculated threshold may be based on characteristics of the job page. For example, the threshold may be based on the number of pages associated with a job. The threshold may also be based on an amount of ink or toner estimated to be necessary for printing of the job. In another embodiment, the threshold may be based on calculation of average consumable use. For example, a trend of ink or toner consumption may be developed for use in determining a consumable threshold level constituting a consumable deficiency. In general, depending on the inputs received by detecting module 224, the predetermined levels can be an upper and/or lower threshold. For example, where detecting module 224 receives input regarding the level of waste in a waste container, an upper threshold may be used; where the input concerns the level of a toner, a lower threshold may be used.

In step 308, if it is determined that no consumable deficiency exists, the exemplary document production system may continue to print in a normal mode. If a consumable deficiency or potential consumable deficiency is determined to exist, the user may be notified of the consumable deficiency in step 310. In some embodiments, the notification may include a pop-up frame, a program launch, an audible alarm, flashing lights, blinking icons, or other methods to alert the user to a consumable deficiency. Furthermore, the user may be provided with assistance in reordering the deficient consumable. For example, the user may be provided with a hyperlink to an Internet URL, where the deficient consumable may be purchased online for in-store pick-up or home delivery by mail. The user may also be given the option to dismiss the notification or to delay (i.e., “snooze”) its reappearance to a later date. In some embodiments, the user may be notified to simply empty a waste container, such as a waste toner module. The user may also be provided with a plurality of options along with the consumable-deficiency notice.

For example, along with the notification, the user may be provided with an option at step 312 to continue printing in a normal mode in step 308 (as would occur if no consumable deficiency were determined) or to print in a draft mode. As illustrated in FIG. 3, upon the selection of a draft mode, the user may be provided with a number of alternate print modes in step 314. In one embodiment, one of the alternate print modes may be automatically selected by the exemplary system depending on the type of consumable and/or the level of consumable deficiency. In some embodiments, the user may select one or more desired print modes using a menu, icon, button, or link displayed in exemplary user interface module 204. For example, the user may be provided with the option of printing in a composite mode as in step 316, a monochrome mode as in step 318, or any suitable consumable-saving mode as in step 320.

In the consumable-saving mode of step 320, the availability of any consumable, including but not limited to ink, toner, ink cartridges, toner cartridges, or paper, may be extended as selected by the user or as determined automatically, by one or more of several suitable methods. For example, the use of ink or toner may be decreased by rendering an image in a lower resolution or alternate dithering pattern. Ink or toner use may also be reduced by reducing print density (i.e., switching from 1200 dpi to 600 dpi). In one embodiment, the resolution or print density may be decreased incrementally as the supply of consumable is detected to have decreased. For example, a printer density may be decreased from 1200 dpi, to 1000 dpi, to 800 dpi, etc. until the consumable is completely depleted or replenished. In another embodiment, ink or toner may be conserved by compressing images prior to, or during, rendering such that printed images take up less surface area on the print medium and therefore require less consumable.

The composite mode of step 316 may be used in the event that a printer has a deficiency of black ink or toner. In composite mode, a composite of colored toners or inks may be used to simulate black. In some embodiments, composite mode may yield a black, near-black, or dark-brown image. This selection may provide the user with sufficient time, between the detection of the deficiency and an impending, complete depletion, to replenish black ink or toner.

In step 318, a user may simply select a monochromatic mode wherein any preferred available ink or toner may be used to print some or all of a document. For example, a multi-colored document may be printed using black ink if one or more colored inks are low or unavailable. In some embodiments, the entire document may be printed in blue ink if black ink is low or unavailable. In one embodiment, the ink or toner with the maximum remaining available capacity may be selected for monochrome printing. In some embodiments, the least used ink or toner may be selected for monochrome printing. Alternatively, the most inexpensive or cost-effective ink or toner may be selected. In some embodiments, an appropriate color may be automatically selected.

Other consumables, such as paper may be conserved by similarly suitable methods such as compressing images so that they cover less area on a printed page. For example, a multi-page document may be printed in a “slide-mode” or “N-up mode” in which more than one document page is printed on a single sheet of paper. In another embodiment, such as with printing devices that include a duplex unit, paper may be conserved by switching into a double-sided printing mode until the supply of paper is replenished. Of course, such paper conserving modes may be selectable by the user, or overridden by the user if automatically selected, in the event that such a mode is undesirable for a particular print job.

As explained above, methods consistent with embodiments of the present invention may conveniently be implemented using program modules, hardware modules, or a combination of program and hardware modules not limited those recited herein. Such modules, when executed, may perform the steps and features disclosed herein, including those disclosed with reference to the exemplary block diagrams and flow chart shown in the figures. The operations, stages, and procedures described above and illustrated in the accompanying drawings are sufficiently disclosed to permit one of ordinary skill in the art to practice the invention. Moreover, there are many computers, printing devices, and operating systems that may be used in practicing embodiments of the instant invention and, therefore, no detailed program could be provided that would be applicable to these many different systems. Each user of a particular system will be aware of the language, hardware, and tools that are most useful for that user's needs and purposes.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to compute-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

In some embodiments, a program for conducting the above algorithm may be recorded on computer-readable media or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to a printing device or computing device. In certain embodiments, portions of a program to implement the systems, methods, and structures disclosed may be delivered over a network.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A method of extending the availability of a printing device comprising:
comparing a detected level of at least one print consumable used by the printing device to a threshold level;
selecting at least one of several printing modes if the detected level of the at least one print consumable is less than the threshold level; and
controlling the printing device to print in the selected printing mode.

2. The method of claim 1, wherein the at least one print consumable comprises one or more of:
ink;
toner;
paper;
space available in a waste container;
transfer belts;
ink cartridges; and
toner cartridges.

3. The method of claim 1, wherein the threshold level is predetermined.

4. The method of claim 1, wherein the threshold level is determined based on image and size characteristics of a current print job.

5. The method of claim 1, wherein the threshold level is determined based on a trend of consumption of the at least one print consumable.

6. The method of claim 1, wherein the selection of one of the printing modes is performed automatically.

7. The method of claim 1, wherein the selection of one of the printing modes is performed by a user.

8. The method of claim 1, wherein one of the selectable printing modes comprises decreasing output resolution of the printed image.

9. The method of claim 1, wherein one of the selectable printing modes comprises simulating black with a composite of colors, if the detected level of black is less than the threshold level for black.

10. The method of claim 1, wherein one of the selectable printing modes comprises rendering an image in a different color, if the detected level of at least one specified color is less than the threshold level for that color.

11. The method of claim 1, wherein the printing device is one of:
a laser printer;
an ink-jet printer;
an LED printer;
a plotter;
a facsimile machine;
a digital copier; and
a multi-function printing device.

12. A computer-readable medium that stores instructions, which when read by a processor perform steps in a method of extending the availability of a printing device, the steps comprising:
comparing a detected level of at least one print consumable used by the printing device to a threshold level;
selecting at least one of several printing modes if the detected level of the at least one print consumable is less than the threshold level; and
controlling the printing device to print in the selected printing mode.

13. The computer-readable medium of claim 12, wherein the at least one print consumable comprises one or more of:
ink;
toner;
paper;
space available in a waste container;
transfer belts;
ink cartridges; and
toner cartridges.

14. The computer-readable medium of claim 12, wherein one of the selectable printing modes comprises decreasing output resolution of the printed image.

15. The computer-readable medium of claim 12, wherein one of the selectable printing modes comprises an option to simulate black with a composite of colors if the detected level of black is less than the threshold level for black.

16. The method of claim 12, wherein one of the selectable printing modes comprises rendering an image in a different color, if the detected level of at least one specified color is less than the threshold level for that color.

17. A system for extending the availability of a printing device comprising:
a detecting module, which detects the level of at least one print consumable used by a printing device;
a selecting module, which selects one of several printing modes, if the detected level of the at least one print consumable is less than a threshold level; and
a controlling module, which controls the printing device to print in accordance with a selected print mode.

18. The system of claim 17, wherein one of the selectable printing modes comprises decreasing output resolution of the printed image.

19. The system of claim 17, wherein one of the selectable printing modes comprises simulating black with a composite of colors if the detected level of black is less than the threshold level for black.

20. The system of claim 17, wherein one of the selectable printing modes comprises rendering an image in a different color, if the detected level of at least one specified color is less than the threshold level for that color.
